(19) United States
(12) Patent Application Publication
(10) Pub. No.: US 2003/0121248 A1
(43) Pub. Date: Jul. 3, 2003

(54) Sealed chain

(76) Inventor: Takashi Nakagawa, Osaka (JP)

Correspondence Address: Kenneth L. Mitchell, Woodling, Krost and Rust, 9213 Chillicothe Road, Kirtland, OH, 44094, US

(21) Appl. No.: 10/318,920

(22) Filed: Dec. 13, 2002

(30) Foreign Application Priority Data
Dec. 27, 2001 (JP) 398307/2001

(51) Int. Cl. F16G 13/06

(52) U.S. Cl. 59/4

(57) ABSTRACT

To provide a sealed chain that can prevent damaging an annular sealing member made of an elastic material without increasing the width size of the chain and can reduce the production cost. In a sealed chain including an annular sealing member 27 made of an elastic material surrounding a pin 25 and attached to an inside surface side of each of outer plates 26, a hollow is formed in a bush press-fitting hole 23a by press-fitting and fixing each of the both end portions of a bush 22 to the bush press-fitting hole 23a so that each of the both end portions of the bush 22 is positioned inside further than the outside surface of the inner plate 23, an outside edge of the bush press-fitting hole 23a is beveled to form a beveled portion 23b, the beveled portion 23b being formed as a beveled portion having a small surface roughness during punching the inner plate 23, so that the annular sealing member 27 made of the elastic member is attached in a compressed manner by the inside surface of said outer plate 26, the outer peripheral surface of said pin 25, an end surface of the bush 22 and the beveled portion 23b while a part of said annular sealing member being positioned in the hollow.

### FIELD OF THE INVENTION

The present invention relates to a sealed chain having an annular sealing member made of an elastic material for preventing a lubricating oil (for example grease) sealed between an outer peripheral surface of a pin and an inner peripheral surface of a bush from leaking outside and at the same time for preventing a foreign material from entering a gap between the outer peripheral surface of the pin and the inner peripheral surface of the bush.

### RELATED ART

General conventional sealed chains include a chain shown in FIG. 2 (see FIG. 1 in Japanese Laid-open Utility Model Publication No. Sho. 54-45864). FIG. 2 is a cross-sectional view of a principal portion of a conventional sealed chain, which is the general sealed chain. The sealed chain shown in FIG. 2 includes inner plates 3 to whose bush press-fitting holes 3a the both end portions of a bush 2 were press-fitted and fixed, a roller 4 rotatably fitted around the outer peripheral surface of the bush 2, outer plates 6 to which the both end portions of a pin 5 fitted into the bush 2 with a clearance were fixed, and O-rings 7 (annular sealing members made of an elastic material) surrounding the outer peripheral surfaces of the protruded portions 2a of the bush protruded from the outside surfaces of the inner plates 3, and attached between the opposed side surfaces of the outer plate 6 and the inner plate 3, and in the sealed chain 1, grease is sealed into between the outer peripheral surface of the pin 5 and the inner peripheral surface of the bush 2 and each O-ring 7 is attached so as to be compressed by the inside surface of the outer plate 6, the outside surface of the inner plate 3 and the outside surface of the protruded portion 2a of the bush 2.

Since in the sealed chain 1 shown in FIG. 2, the O-ring 7 (annular sealed member made of an elastic material) surrounds the outer peripheral surface of the protruded portion 2a of the bush 2 protruded from the outside surface of the inner plate 3 and is attached between the opposed sides of the outer plate 6 and the inner plate 3, the width size of this sealed chain 1 becomes larger than the width size of a standard chain defined in the JIS standards or the like, the standard chain having no O-ring (hereinafter referred to as only a standard chain), and there was a problem that a multi row chain or a conveying chain with attachment has no compatibility.

In the sealed chain 1 shown in FIG. 2 the O-ring 7 (annular sealing member made of an elastic material) is attached in a compressed manner by the inside surface of the outer plate 6, the outside surface of the inner plate 3 and the outer peripheral surface of the protruded portion 2a of the bush 2. Thus it is necessary to make the surface roughness of the portions of the inside surface of the outer plate 6, the outside surface of the inner plate 3 and the bush 2, on which the O-ring abuts, small. However, since it is impossible to make the surface roughness of only the portions, on which the O-ring abuts, small, working to make the surface roughness of the respective entire surfaces of the outer plate 6, the inner plate 3 and the bush 2 small has been carried out by barreling. However, the barreling has a problem of low productivity, which leads to increase the cost.

Thus, the present inventor filed, as Japanese Patent Application No. 2000-353285, a sealed chain which has a compatibility with a standard chain without increasing the width size of the chain even if the O-ring is attached to the chain. FIG. 3 is a cross-sectional view of the principal portion showing one example of the sealed chain according to the prior application. A sealed chain 11 shown in FIG. 3 includes inner plates 13 to whose bush press-fitting holes 13a the both end portions of a bush 12 were press-fitted and fixed, a roller 14 rotatably fitted around the outer peripheral surface of the bush 12, outer plates 16 to which the both end portions of a pin 15 fitted into the bush 12 with a clearance were fixed, and O-rings 17 (annular sealing members made of an elastic material) surrounding the pin 15 and attached on the inside surface side of the outer plate 16, and in the sealed chain 11, grease is sealed into between the outer peripheral surface of the pin 15 and the inner peripheral surface of the bush 12. Further, in the sealed chain 11, a hollow is formed in the bush press-fitting hole 13a by press-fitting and fixing the both end portions of the bush 12 so that the both end surfaces of the bush 12 are positioned inside further than the outside surfaces of the inner plates 13 and each O-ring 7 is attached so as to be compressed by the inside surface of the outer plate 16, the outer peripheral surface of the pin 15, an end surface of the bush 12 and the inner plate 13 with a portion of the O-ring being positioned in the hollow.

Problems to be Solved by the Invention

In the sealed chain 11 shown in FIG. 3, when the O-ring 17 (annular sealing member made of an elastic material) is compressed and crushed by the inside surface of the outer plate 16, the outer peripheral surface of the pin 15, the end surface of the bush 12 and the inner plate 13, an outer edge 13e of the bush press-fitting hole 13a is engaged into the O-ring 17. As a result there was a problem that the O-ring 17 is damaged and the life of the O-ring is affected.

Accordingly, the objects of the present invention are to solve the above-mentioned problems and to provide a sealed chain that can prevent damaging an annular sealing member made of an elastic material without increasing the width size of the chain and can reduce the production cost.

Means for solving the Problems

The invention according to claim 1 is a sealed chain including inner plates to whose bush holes the both end portions of a bush are press-fitted and fixed, outer plates to which the both end portions of the pin fitted in said bush with clearance are fixed, and an annular sealing member made of an elastic material surrounding said pin and attached to an inside surface side of each of said outer plates, wherein a hollow is formed in said bush press-fitting hole by press-fitting and fixing each of said both end portions of said bush to said bush press-fitting hole so that each of said both end portions of said bush is positioned inside further than the outside surface of said inner plate, an outside edge of said bush press-fitting hole is beveled to form a beveled portion so that said annular sealing member made of the elastic member is attached in a compressed manner by the inside surface of said outer plate, the outer peripheral surface of said pin, an end surface of said bush and said beveled portion while a part of said annular sealing member being positioned in said hollow.

The invention of claim 2 is the invention of claim 1, wherein said beveled portion is formed to be a beveled portion having a small surface roughness during punching said inner plate.

Action

In the inventions of claims 1 and 2, the annular sealing member made of an elastic material abuts on the beveled portion in the inner plate. Thus the damage of the annular sealing member made of an elastic material can be prevented without increasing in the width size of the chain.

In the invention of claim 2, the annular sealing member made of an elastic material abuts on a beveled portion having a small surface roughness in the inner plate. However, the beveled portion having the small surface roughness is formed during punching the inner plate by a press. Therefore, the production cost of the chain can be reduced as compared with a case where the entire inner plate is barreled.

A better understanding of the invention will be had when reference is made to the Brief Description of the Drawings, Description of the Invention and Claims which follow hereinbelow.

### BRIEF DESCRIPTION OF THE DRAWINGS

FIG. 1 is a cross-sectional view of the principal portion of a sealed chain according to an embodiment of the present invention.

FIG. 2 is a cross-sectional view of the principal portion of a conventional sealed chain.

FIG. 3 is a cross-sectional view of the principal portion showing an example according the prior application

A better understanding of the invneiton will be had when reference is made to the Description of the Invention and Claims which follow hereinbelow.

### DESCRIPTION OF THE INVENTION

Description of Reference Numerals

21 . . . Sealed chain

22 . . . Bush

23 . . . Inner plate

23a . . . Bush press-fitting hole

23b . . . Beveled portion

24 . . . Roller

25 . . . Pin

26 . . . Outer plate

27 . . . O-ring (annular sealing member made of an elastic material)

Embodiments of the Invention

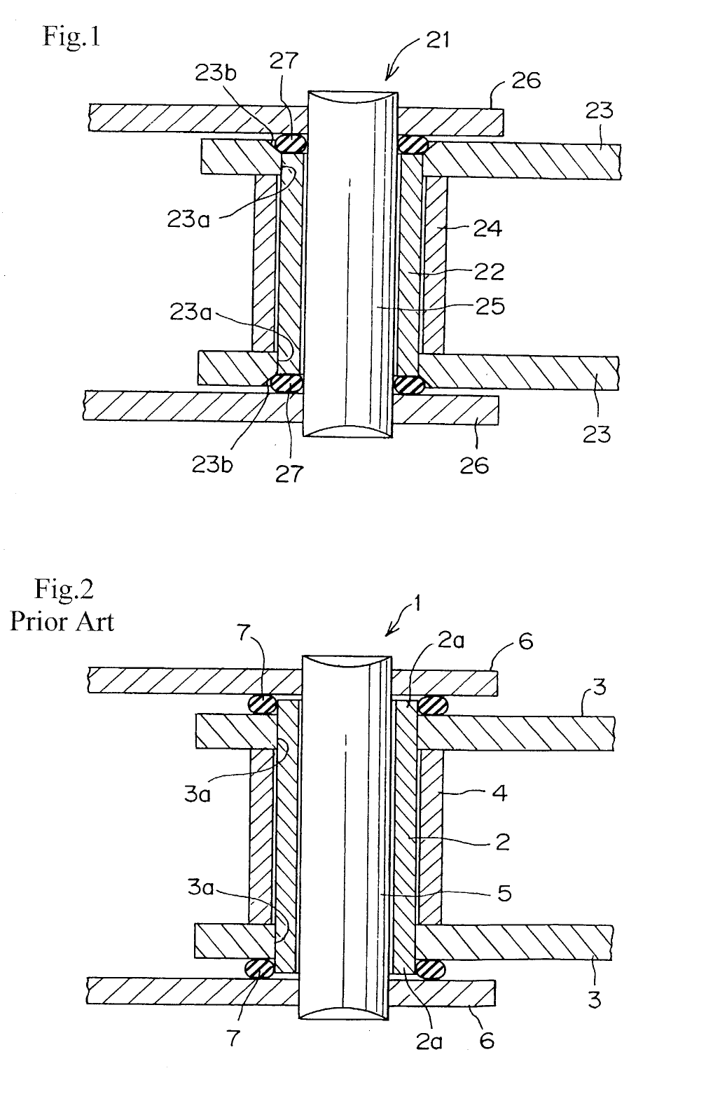

A sealed chain according to an embodiment of the invention will be described with reference to FIG. 1. FIG. 1 is a cross-sectional view of the principal portion of a sealed chain according to an embodiment of the invention. The sealed chain 21 shown in FIG. 1 includes inner plates 23 to whose bush press-fitting holes 23a the both end portions of a bush 22 were press-fitted and fixed, a roller 24 rotatably fitted around the outer pertipheral surface of the bush 22, outer plates 26 to which the both end portions of a pin 25 fitted into the bush 22 with clearance were caulking-fixed, and O-ring 27 (annular sealing member made of an elastic material) surrounding the pin 25 and attached to the inside surface side of the outer plate 26. And a lubricating oil (for example grease) is sealed into between the outer peripheral surface of the pin 25 and the inner peripheral surface of the bush 22.

Further, a hollow is formed in the bush press-fitting hole 23a of the inert plate 23 by press-fitting and fixing each of the both end portions of the bush 22 so that each of the both end portions of the bush 22 is positioned further inside than the outside surface of the inner plate 23 that is so that each of the both end surfaces of the bush 22 is in a recessed manner from the outside surface of the inner plate 23. Further, an outer edge of the bush press-fitting hole 23a of the inner plate 23 is beveled to form a beveled portion 23b.

Further, the beveled portion 23b is formed to have a small surface roughness. The beveled portion 23b formed so as to have the small surface roughness is formed when the inner plate 23 is punched by a press. That is, when the inner plate 23 is punched by the press, the beveled portion 23b having a small surface roughness can be formed by the use of a mold a portion of which corresponding to the beveled portion 23b was subjected to finishing.

The O-ring 27 (annular sealing member made of an elastic material) surrounds the pin 25 and is attached so that a part of the O-ring 27 is positioned in a hollow formed in the bush press-fitting hole 23a of the inner plate 23 on the inside surface side of the outer plate 26. Further, the O-ring 27 is attached in a compressed manner by the inside surface of the outer plate 26, the outer peripheral surface of the pin 25, the end surface of the bush 22 and the beveled portion 23b.

In the sealed chain 21 the attachment of the above-mentioned O-ring 27 prevents a lubricating oil (for example grease) sealed into between the outer peripheral surface of the pin 25 and the inner peripheral surface of the bush 22 from leaking outside and prevents a foreign material from entering a gap between the outer peripheral surface of the pin 25 and the inner peripheral surface of the bush 22 from the outside.

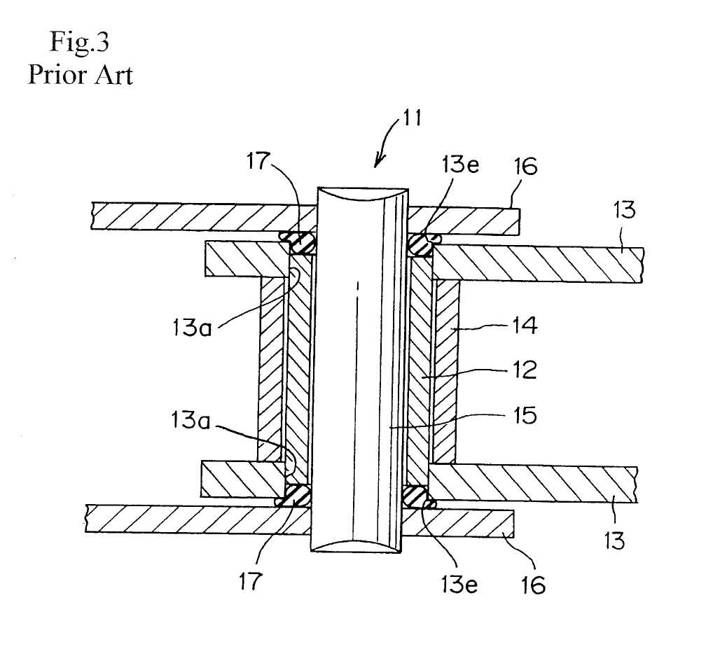

According to the thus formed sealed chain 21 shown in FIG. 1, the O-ring 27 was attached in a surrounded and compressed manner by the inside surface of the outer plate 26, the outer peripheral surface of the pin 25, the end surface of the bush 22 and the beveled portion 23b. Thus, the O-ring 27 abuts on the beveled portion 23b in the inner plate 23 and it cannot be damaged by the outer edge 13e of the bush press-fitting hole 13a unlike the sealed chain 11 shown in FIG. 3

Further, the O-ring 27 abuts on the beveled portion having a small surface roughness in the inner plate 13. The beveled portion 23b having the small surface roughness is formed by punching by a press. Thus, the production cost of the sealed chain can be reduced as compared with a conventional case where the entire inner plate 23 is barreled.

In the sealed chain shown in FIG. 1, the outer edge of the bush press-fitting hole 23a in the inner plate 23 is linearly beveled in a cross-section to form the beveled portion 23b. However, it is noted that in place of the beveling linearly in a cross-section, curved or rounded (R) beveling may be used. When beveled in a rounded shape, a new edge cannot be more preferably generated unlike the linear beveling. Even when the outer edge of the bush press-fitting hole 23a is beveled in a rounded (R) shape, the rounded beveled portion having a small surface roughness can be formed by the use of a mold a portion of which corresponding to the beveled portion was subjected to finishing, during punching the inner plate 23 by a press.

Further, the sealed chain shown in FIG. 1 is a roller chain having the roller 24, but the present invention can be applied to a bush chain having no roller.

Effects of the Invention

According to the inventions of claims 1 and 2, the following effects can be exerted. That is, the annular sealing member made of an elastic material abuts on the beveled portion in the inner plate, and it cannot be damaged by the outer edge of the bush press-fitting hole unlike the sealed chain shown in FIG. 3 whereby the deterioration of the annular sealing member made of an elastic material is prevented and long life of the sealed chain can be obtained.

According to the invention of claim 2, in addition to the above-described effects, the following effects can be exerted. The annular sealing member made of an elastic material abuts on the beveled portion having a small surface roughness in the inner plate. The beveled portion having the small surface roughness is formed by punching by a press. Thus, the production cost of the sealed chain can be reduced as compared with a conventional case where the entire inner plate is barreled.

The invention has been described herein by way of example only and those skilled in the art will readily recognize that changes may be made to the invention as described herein without departing from the spirit and scope of the claims which follow hereinbelow.

I claim:

1. A sealed chain including inner plates to whose bush holes the both end portions of a bush are press-fitted and fixed, outer plates to which the both end portions of the pin fitted in said bush with clearance are fixed, and an annular sealing member made of an elastic material surrounding said pin and attached to an inside surface side of each of said outer plates, wherein a hollow is formed in said bush press-fitting hole by press-fitting and fixing each of said both end portions of said bush to said bush press-fitting hole so that each of said both end portions of said bush is positioned inside further than the outside surface of said inner plate, an outside edge of said bush press-fitting hole is beveled to form a beveled portion so that said annular sealing member made of the elastic member is attached in a compressed manner by the inside surface of said outer plate, the outer peripheral surface of said pin, an end surface of said bush and said beveled portion while a part of said annular sealing member being positioned in said hollow.

2. A sealed chain according to claim 1, wherein said beveled portion is formed to be a beveled portion having a small surface roughness during punching said inner plate.
